(19) United States
(12) Patent Application Publication
(10) Pub. No.: US 2022/0166763 A1
(43) Pub. Date: May 26, 2022

(54) SYSTEM AND METHOD FOR MANAGING INTEGRATED ACCOUNT BASED ON TOKEN

(71) Applicant: Bespin Global Inc., Seoul (KR)

(72) Inventors: Sung Ho HONG, Yongin-si (KR); Wi Cheol PARK, Yongin-si (KR)

(73) Assignee: Bespin Global Inc., Seoul (KR)

(21) Appl. No.: 17/100,767

(22) Filed: Nov. 20, 2020

(51) Int. Cl. H04L 29/06; H04L 29/08

(52) U.S. Cl. CPC H04L 63/0807; H04L 63/102; H04L 67/22; H04L 63/107; H04L 63/108; H04L 63/105

(57) ABSTRACT

The present disclosure relates to a system and method for managing an integrated account based on a token. A role is automatically set and changed by matching the location and work environment of a user to the account of the user based on information on a task schedule or moving location of the user. Accordingly, a plurality of accounts can be effectively managed. Management convenience can be greatly improved by clarifying an execution target with respect to a manipulation performed in an account and clarifying a reason for the manipulation. Security can be enhanced by restricting a role based on a designated task schedule or an access location.

### BACKGROUND OF THE DISCLOSURE

### Field of the Disclosure

The present disclosure relates to a system and method for managing an integrated account based on a token, and to a system and method for managing an integrated account based on a token, wherein accounts are integrated and managed between a plurality of clouds and a role on an account is automatically assigned.

### Description of Related Art

A cloud system provides an environment in which a virtual server is accessed through a terminal to freely implement a desired service.

The cloud system includes a service in which some storage space is leased to a user and the user accesses the cloud systems through a terminal and stores data in the assigned space, a service that provides infrastructure, such as a basic computing environment or a network service, and a platform service that provides a platform or solution for using a computer. Furthermore, the cloud systems include software services in which application software is available over a network.

The cloud system is used in various field, such as a mobile application, game, a shopping mall, and social networking services.

In the cloud systems, a user who uses or provides a service can use resources without temporal and spatial restrictions and also check a present use status in real time.

Accordingly, recently, multiple companies transfer their IT assets within companies to cloud environments and operate customer services and a series of tasks through the cloud environments.

As various data is handled in the cloud environment, there is an increasing interest in security, such as controlling access rights to the cloud.

Due to the nature of the cloud, security greatly depends on identity and access management (IAM) service for cloud services provided by cloud service providers, such as AWS and MS, because physical control over access rights is impossible. A technology represented as IAM enables a role capable of accessing a cloud service to be edited in detail, and provides a log for the activity of an accessed user.

Furthermore, the technology may control erroneous access by a user through an additional secure device, such as multi-factor authentication (MFA).

However, a current IAM function provided by a cloud service provider still has many problems in security, in particular, many problems in usability.

Korean Patent Application Publication No. 10-2018-0068514 provides a cloud-based virtual security service in order to solve such security problems. However, such a security service is also based on the cloud, and has a problem in that it does not guarantee security for the cloud service itself.

In relation to the cloud service, Amazon Web Services (AWS), that is, a representative cloud service occupying most of a global market share, provides IAM services separated for each account unit. An AWS user may generate several accounts if necessary, and AWS has a problem in that one company has to generate several accounts in order to separate and manage resources for each task or department to be chiefly managed.

The IAM service of AWS depends on each account. Accordingly, if a specific user requires a role to access a plurality of AWS accounts, there is a problem in that the user has to set access rights through each IAM service of an AWS account to be accessed.

Accordingly, since a plurality of IAM accounts has to be generated for one user, an administrator who has to control an access environment of an AWS environment within a company has to manage more IAM accounts than the actual number of users.

Accordingly, there are problems in that work efficiency is low and it is difficult to accurately check a real user of each account. Such a method may become a cause for a serious security accident.

Furthermore, an administrator who manages the cloud of a company has to restrict a not-permitted place and access by a user, continue to monitor the login history of a user, and maintain security by confirming whether a login history is contrary to a security policy, in a cloud environment.

If a company manages a plurality of cloud services and manages different accounts for each task or department, there are problems in that an administrator has to monitor all of a plurality of accounts for the respective cloud services and the number of accounts to be monitored is greatly increased.

An increase in the number of accounts to be managed becomes a great factor that increases management cost because more manpower needs to be input in order to maintain security.

A user is greatly inconvenienced due to a strong security policy of a company because the user has to perform an infrastructure management task using a permitted IP or only in a designated place.

In particular, in order to handle a problem occurring on the outside of a company, for example, after work, a corresponding user has to visit his or her office because he or she has to move to a designated place although a corresponding task is a simple task.

Although access to an account is restricted through an access IP or a designated location, a security issue may still occur because there is no method of identifying whether a user who accesses an account is a legitimate user, for example, whether access is access using hacking.

As described above, the cloud service has a problem in that convenience of a user who uses the service is degraded if a provider (e.g., company) providing the service tightens security in a cloud environment. Accordingly, there is a need for a method capable of tightening security while improving user convenience.

### SUMMARY OF THE DISCLOSURE

An object of the present disclosure is to provide a system and method for managing an integrated account based on a token, wherein a role is automatically set and changed by matching the location and work environment of a user and the account of the user based on information on a task schedule or moving location of the user.

An object of the present disclosure is to provide a system and method for managing an integrated account based on a token, wherein accounts for a plurality of cloud services are integrated and managed.

An object of the present disclosure is to provide a system and method for managing an integrated account based on a token, wherein user convenience is improved and security is enhanced by changing a role in accordance with a change in a location and work environment of a user.

Technical objects to be achieved in the present disclosure are not limited to the aforementioned technical objects, and other technical objects not described above may be evidently understood by a person having ordinary skill in the art to which the present disclosure pertains from the following description.

In an aspect, a system for managing an integrated account based on a token includes a plurality of cloud systems configured to provide cloud services, a terminal configured to access the plurality of cloud systems using an integrated account to which a role has been assigned and to be provided with resources and a management server configured to manage a plurality of integrated accounts so that the terminal accesses the plurality of cloud systems using the integrated account. The management server includes a management unit configured to register the integrated account for accessing the plurality of cloud systems and assign the role on the integrated account based on preset location information and schedule information of the terminal, and an access unit configured to authenticate the access to the plurality of cloud systems using the integrated account. The access unit simplifies an authentication system by managing the access to the cloud services using the integrated account based on a multi-token. The management unit maps the integrated account to a role for access to the cloud systems and outputs information on an accessible cloud service based on the location information or the schedule information.

The management unit automatically changes the role on the integrated account based on the location information or the schedule information.

When the terminal accesses the cloud system, providing the cloud service, using the integrated account, the management unit stores history data related to a service, resources, and a work history used in the integrated account.

The management unit maps the integrated account and access rights to a requested cloud service, among the cloud services of the plurality of cloud systems, so that the terminal is connected to the plurality of cloud systems using the integrated account, without registering individual accounts with the plurality of cloud systems.

The access unit determines whether an IP of the integrated account is changed or whether an access time is an access permission time based on a schedule, while the terminal accesses the cloud systems using the integrated account, and releases the access of the terminal with respect to a not-permitted IP or schedule

The management unit manages multiple accounts for a cloud system to be accessed based on only primary authentication for the integrated account.

In an aspect, a method of controlling an integrated management system includes generating an integrated account connected to a plurality of cloud systems providing cloud services, mapping the integrated account and a role for access to the cloud systems, assigning a role to the integrated account based on location information or schedule information set in the integrated account, attempting to access, by a terminal, any one of the plurality of cloud systems using the integrated account, performing authentication on the integrated account based on a multi-token and determining whether to permit the access to the cloud system based on the role assigned to the integrated account, outputting information on an accessible cloud service based on the location information or the schedule information, and accessing, by the terminal, the cloud systems to which the access is permitted and being provided with the cloud service.

The method further includes determining whether to permit an IP assigned to the integrated account based on the location information of the integrated account, and determining whether an access time is time when access is permitted based on the schedule information of the integrated account.

### BRIEF DESCRIPTION OF THE DRAWINGS

FIG. 1 is a diagram illustrating a configuration of a system for managing an integrated account based on a token according to the present disclosure.

FIG. 2 is a diagram schematically illustrating a configuration of a management server of the system for managing an integrated account based on a token according to the present disclosure.

FIG. 3 is a diagram illustrating an embodiment according to a connection with the management server of the system for managing an integrated account based on a token according to the present disclosure.

FIG. 4 is a diagram to which reference is made to describe a change in the role of an account based on a location of the system for managing an integrated account based on a token according to the present disclosure.

FIG. 5 is a diagram to which reference is made to describe the setting of a role on an account based on a task schedule of the system for managing an integrated account based on a token according to the present disclosure.

FIG. 6 is a diagram to which reference is made to describe a connection based on a token in the system for managing an integrated account based on a token according to the present disclosure.

FIG. 7 is a flowchart illustrating an access restriction method based on a location or schedule in the system for managing an integrated account based on a token according to the present disclosure.

### DESCRIPTION OF SPECIFIC EMBODIMENTS

Advantages and characteristics of the present disclosure and a method for achieving advantages and characteristics will become apparent from embodiments described in detail with reference to the accompanying drawings. However, the present disclosure is not limited to the disclosed embodiments, but may be implemented in various other forms. The present embodiments are only provided to complete the present disclosure and to allow those skilled in the art to which the present disclosure pertains to fully understand the category of the present disclosure. The present disclosure is defined by the category of the claims. The same reference numbers are used to refer to the same or similar parts throughout the specification. A control element of the present disclosure may be configured as at least one processor.

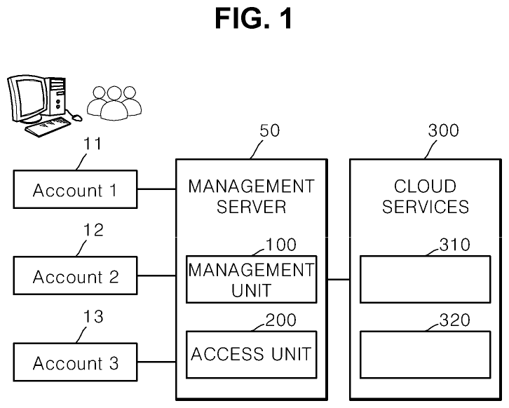

FIG. 1 is a diagram illustrating a configuration of a system for managing an integrated account based on a token according to the present disclosure.

As illustrated in FIG. 1, the system for managing an integrated account based on a token according to the present disclosure includes a plurality of cloud systems providing a plurality of clouds services 300 and a management server 50 for controlling access to the cloud services through the terminal 10 of a user 1 and managing the account 90 of the user 1. The user accesses the cloud service through the terminal 10.

The system for managing an integrated account based on a token is operated in an Internet service environment in which a plurality of networks is interconnected. The system is connected to a plurality of cloud systems, and provides the cloud services to a user, integrates and manages accounts for a plurality of cloud services, and restricts access to the cloud service by managing access rights to the account of the user.

The cloud services 300 provided by cloud systems may provide various services, such as a service for providing a storage space and a service for providing infrastructure, a platform, and software. For example, a cloud server provides various cloud services, such as QWS, Azure, and Soft-layer, and also provides IDC service.

The management server 50 is connected to the cloud services 300 (310 to 330) of a plurality of cloud systems, and generates and manages an account for using each cloud service.

Furthermore, the management server 50 changes a role on an account based on a location where a user accesses the cloud services, a terminal used by a user, and a task schedule of a user.

The management server 50 enables a user to use a plurality of cloud services based on one account by generating the one account for one cloud service without individually generating accounts for the plurality of cloud services in cloud systems, respectively.

The management server 50 supports a user to use the plurality of cloud services using one account according to an agreement with cloud services which may be integrated and managed.

Furthermore, the management server 50 enables a user to generate an account for the IAM service of the management server and to use the plurality of cloud services.

The management server 50 performs authentication based on a token, and thus simplifies an authentication system and provides a user with services of a plurality of cloud systems by enabling a user to manage access to the plurality of cloud systems and set a role using an integrated account.

The management server 50 connects a plurality of cloud systems to an integrated account, manages the plurality of cloud systems, and processes service access by providing the plurality of cloud systems with authentication based on a token through the authentication based on a token for the integrated account.

The management server 50 provides a user with cloud services for a plurality of cloud systems through an integrated account based on a token regardless of a service provider (hereinafter referred to as an “SP”) without being limited to a specific SP and a corresponding subsidiary.

An authentication method based on a token can perform authentication processing based on multi-sign-in access because authentication can be requested through any server without the need to request authentication from a specific server compared to a conventional server authentication method, can prevent an overload of a server because it is not necessary to maintain a session, does not require the use of cookies, and enables a role for the plurality of cloud services to be shared.

The management server 50 issues a token for access or a service request using the terminal 10 of the user, and manages the issued token. The terminal 10 of the user stores the issued token, and requests access from the management server along with the token when subsequently accessing a service.

Accordingly, the management server 50 may process access by a user by verifying the validity of a token received from a terminal, process access to the plurality of cloud services by processing authentication for an integrated account based on a multi-token, and provides the cloud services to the terminal 10 in response to a request from the user.

The management server 50 enables one user 1 to generate one account in using the cloud services 300 through the terminal 10 and to use the plurality of cloud services 300 using the one account through authentication based on a multi-token. The management server 50 may restrict the generation of a plurality of accounts by one user.

Furthermore, the management server 50 monitors the accounts 91 to 93 of a plurality of users and changes access rights to cloud services, when the plurality of users uses the cloud services using their accounts through terminals 11 to 13, respectively.

The management server 50 integrates and manages the plurality of cloud services, processes the delegation of access rights to the account of a user in order for the user to use the cloud services, and performs authentication by proxy for a single sign-on (SSO) system.

Furthermore, the management server 50 performs integrated authentication using extranet access management (EAM) and identity and access management (IAM), and provides multiple sign-in access authentication and management service based on SAML2.0.

Access to a specific cloud system can be processed by performing authentication by proxy or authentication management on a plurality of authentication management systems through an integrated account based on a multi-token.

The terminal 10 of the user is a device capable of transmitting and receiving data through a network connection. A computer, a notebook, a laptop, a smartphone, a PDA, a tablet PC, or a wearable device may be used as the terminal 10. Other devices capable of accessing the cloud services without being limited thereto may be applied as the terminal 10.

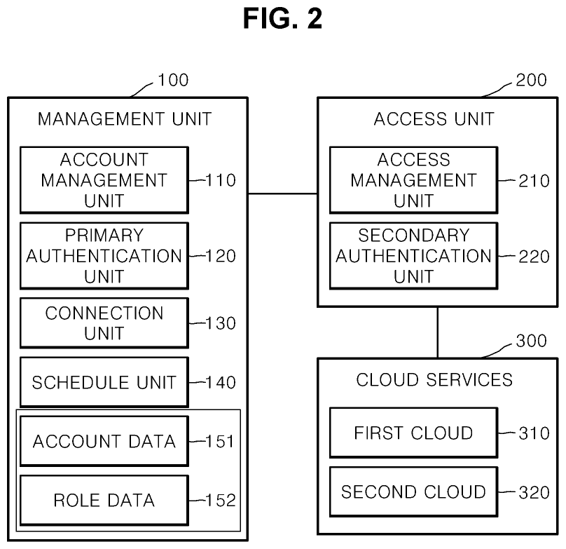

FIG. 2 is a diagram schematically illustrating a configuration of a management server of the system for managing an integrated account based on a token according to the present disclosure.

As illustrated in FIG. 2, the management server 50 includes a management unit 100 for storing and managing account information on the plurality of cloud services 300 and an access unit 200 for managing and authenticating access to the plurality of cloud services by a user through the terminal 10.

The management unit 100 stores and manages account information on the plurality of cloud services 300, and provides an interface module for a cloud account.

Furthermore, the management unit 100 assigns a cloud role on a cloud account to user information and group of an identity provider (hereinafter referred to as an “IdP”), and provides an access history for each user.

The management unit 100 is an integrated relay module using IAM and EAM, and performs IAM for realizing single sign-on (SSO) that enables the plurality of cloud services to be used as one account.

The management unit 100 includes an account management unit 110, a primary authentication unit 120, a connection unit 130, a schedule unit 140, and a data unit 150.

The account management unit 110 sets and manages an integrated account.

The account management unit 110 generates the account of a user for using the plurality of cloud services, manages the generated account, and assigns, to the account, access rights to the cloud services.

The account management unit 110 is for integrating and managing the accounts of a user, and it may register, with the IdP, an integrated account and role information for the plurality of cloud services and may modify information changed in accordance with a role connected to an account.

The account management unit 110 provides an interface for a cloud account, connects, to an integrated account, the user of the IdP and a role group for the plurality of cloud services, and assigns a role to the integrated account.

Furthermore, the account management unit 110 records and stores a series of events occurring in account management and role assignment for an integrated account, and provides a history management function capable of inquiring into the recording of an event for a change in a related role.

In order to register the integrated account of a user, the account management unit 110 generates account and role information for connecting to the role module of the IdP in each cloud. The account management unit 110 can improve convenience and efficiency in managing a plurality of accounts for a plurality of users by managing the integrated account through the IdP.

In the case of AWS, the account management unit 110 generates IdP information using metadata provided by the IdP, generates an IAM role suitable for an object in a management console, registers the IAM role with the management unit 100, and completes the registration of integrated account information by setting a console access validity time suitable for the purpose of use for the cloud services.

The account management unit 110 may connect user information and integrated account role of the IdP in a 1:1, 1:N or N:N way in order to manage access to the cloud services for each user.

Furthermore, the account management unit 110 may generate and register a group for a user in order to supplement inconvenience of role information management in a user unit. The account management unit 110 generates access management information on(based on?) which the same rights can be assigned to a plurality of users included in a registered group en bloc by connecting a cloud account role to the group.

The account management unit 110 manages an account used in each SP, a role on the account, and a group of accounts, with respect to the plurality of cloud services.

The account management unit 110 is configured with a mapping module for mapping a role on the registered account of a user and a schedule module for performing access control over a user.

The account management unit 110 assigns a specific role to the integrated account of a user when the role is set for the integrated account, and permits or restricts access by the user based on the role when the user actually accesses a service.

Furthermore, the account management unit 110 stores a location where a user accesses a service using an account and corresponding task contents, and stores and manages an access history.

The primary authentication unit 120 performs authentication on the integrated account of a user.

When a user logs in to a system using an integrated account in order to use the cloud services, the primary authentication unit 120 checks whether a schedule is an accessible schedule based on the access IP of a logged-in terminal and a task schedule of the user.

The primary authentication unit displays the account and role of an accessible SP based on the location of a user and a previously registered task schedule.

If a specific cloud service of the plurality of cloud services can be accessed, the primary authentication unit 120 may display information on the corresponding cloud service.

In this case, the account management unit 110 may operate in conjunction with the account of the user, may operate in conjunction with an account for a group, and may control access.

The account management unit 110 registers, with an integrated authentication system, the account and role information of an SP to operate in conjunction therewith, maps the account and role information to an integrated account, and sets an access control method.

The account management unit 110 registers, with an integrated authentication system, the account and role information of an SP to operate in conjunction therewith, maps the account and role information to an integrated account group, and sets an access control method for a group user through schedule registration, if necessary.

The account management unit 110 may assign a role so that a specific user may access the cloud services based on the location of the user.

Furthermore, the account management unit 110 may assign a role based on a previously registered task schedule so that a specific user may access the cloud services based on the role of a specific account for a specific time.

In order to access resources of the cloud services, the account management unit 110 may select the account role of a user, and may set time when access is permitted. Furthermore, the account management unit may map the user to the corresponding account role or may map a user group to the corresponding account role.

The account management unit 110 stores, as role data, information based on such setting.

When the account management unit 110 sets the role, the user may access resources because the role is assigned to the user based on a specific location or the role is assigned to the user for a specific time.

The account management unit 110 may set a role so that access to resources other than a specific location or a specific time is rejected. The specific location is a location or IP address registered by a user. The specific time is time based on a task schedule.

For example, the account management unit 110 may set a role so that resources of a service C can be used for time B at a point A. Furthermore, the account management unit 110 may set a role so that all resources can be used regardless of time with respect to access at the point A, and may also set a role so that access is possible regardless of a location for the time B.

The connection unit 130 maps each role to an integrated account, and manages the accounts as a group.

The schedule unit 140 performs access control over a user. The schedule unit 140 confirms a location using an access location using the terminal of the user, that is, an IP, and stores and manages the task schedule of the user.

The schedule unit 140 may set an access control method for a user by registering an IP restriction or a schedule.

When a location and a schedule are changed in response to a request from the management unit, the schedule unit 140 provides corresponding information. Furthermore, the schedule unit 140 checks whether a current location of a terminal is identical with an access location (IP) of the terminal in response to the request.

The access unit 200 performs service access by confirming a role on an account.

The access unit 200 authenticates and manages SAML2.0-based multi-sign-in access based on a multi-token with respect to the plurality of cloud services, and performs a simplified authentication system service for the plurality of cloud services using the multi-token.

The access unit 200 may inquire into secondary console access authentication for enabling the user of a logged-in IdP to directly access the console of a multi-cloud, an access account list, and an access history, based on the user account of the IdP generated by the management unit 100 and role mapping information based on a role of an integrated account.

The access unit 200 authenticates a role through SAML association in order to access an SP to operate in conjunction with an account managed by the management unit, and performs secondary authentication for access.

The access unit 200 provides a simplified authentication system service based on a multi-token using an integrated account. The access unit 200 includes an access management unit 210 and a secondary authentication unit 220.

The access management unit 210 checks an IP to which login is permitted and a schedule set to be accessed with respect to an integrated account, and controls access by restricting login to an SP through the integrated account.

After the primary authentication of the management unit, the secondary authentication unit 220 performs secondary authentication on a user.

When an accessible account and role are selected and access is attempted, the secondary authentication unit 220 checks the validity of the account and the role using the SAML 2.0 method with respect to an SP in response to the access request. If the access request is a legitimate request as a result of the check, the secondary authentication unit 220 enables a corresponding service to be accessed.

The secondary authentication unit 220 operates on the assumption that a target service (or SP) can operate in conjunction with SAML2.0. A premise is that a cloud account provided by the target service and a role on the cloud account have been defined.

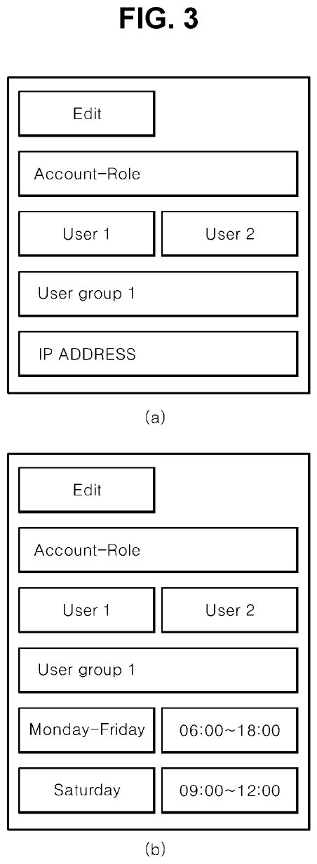

FIG. 3 is a diagram illustrating an embodiment according to a connection with the management server of the system for managing an integrated account based on a token according to the present disclosure.

As illustrated in FIG. 3, the management server 50 of the IAM system manages accounts.

As illustrated in FIG. 3(a), the management unit 100 sets an access console connection and manages an account, based on the location of an account, that is, an access location of a user.

The management unit 100 may set or modify the account of a user based on a modification key, an account role, the user, a user group, or an IP address.

The management unit 100 manages access to a user account by comparing a location where a registered user or a user group accesses a service, that is, an IP used upon access, with a designated IP.

Furthermore, as illustrated in FIG. 3(b), the management unit 100 sets an access console connection of a user and manages an account based on a schedule (i.e., a day/time).

The management unit 100 may set or modify the account of a user by inputting a modification key, an account role, the user, a user group, or a schedule for a day and time.

The management unit 100 manages access to a user account based on a registered user or user group and a designated schedule.

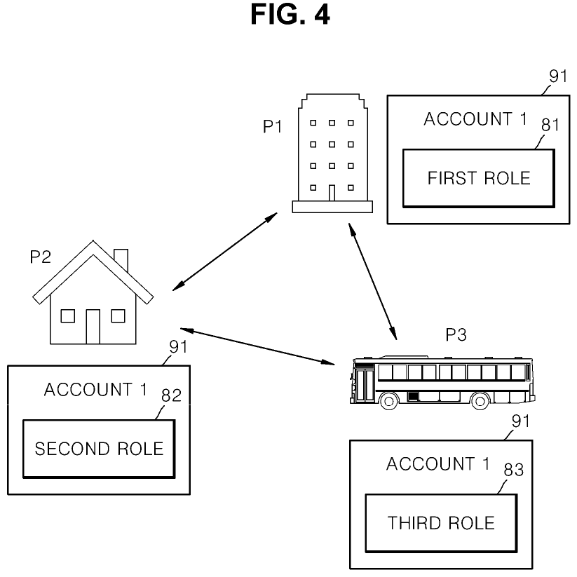

FIG. 4 is a diagram to which reference is made to describe a change in the role of an account based on a location of the system for managing an integrated account based on a token according to the present disclosure.

As illustrated in FIG. 4, a user may access the cloud services 300 at a plurality of locations P1 to P3 through the terminal 10.

The user accesses the cloud services using an integrated account 91 at the office of a company P1. Furthermore, the user may access the cloud services using the integrated account 91 in a house P2. Furthermore, while moving, the user may access the cloud services using integrated account 91 in transportation means P3.

In this case, the management unit 100 may assign a first role 81 to the company P1, assign a second role 82 to the house P2, and assign a third role 83 to the transportation means P3, based on a previously registered location or schedule.

Different types of resources permitted for the cloud services may be set for the first to third roles. Furthermore, the first to third roles may be for read or write permission or access blocking for the resources.

For example, a user may access the cloud services at the company P1 and process resources according to the first role using the integrated account. Access to the cloud services by the user may be blocked according to the third role in transportation means, such as a bus, a subway, or a personal vehicle. Furthermore, if the user accesses the cloud services in the house, the user may access the cloud services only after p.m. 7 according to the second role using the integrated account.

Although the user accesses the cloud services using the same integrated account through the same terminal 10 while moving, the management unit automatically changes a role on the integrated account based on an accessed IP or a previously registered schedule.

Accordingly, the user may access the cloud services according to a role changed based on a location or schedule, and may process a designated task.

The management server 50 can prevent inappropriate access by a user, an inappropriate use of a service, and an accident, such as hacking, by changing a role on an integrated account based on a location or schedule of the user and restricting access.

When access is performed using an integrated account, the management server 50 stores, as history data, an access location and a history of a performed task. Accordingly, the administrator of the management server can monitor the integrated account based on the history data.

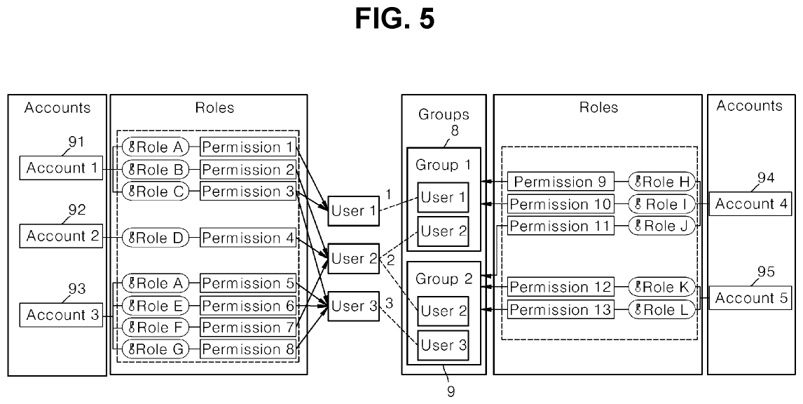

FIG. 5 is a diagram to which reference is made to describe the setting of a role on an account based on a task schedule of the system for managing an integrated account based on a token according to the present disclosure.

As illustrated in FIG. 5, first to third users 1, 2, and 3 may form a first group 8 or a second group 9.

The management server 50 registers, as a first account to a fifth account 91 to 95 for the users or groups, an integrated account for using the plurality of cloud services.

First to third roles A, B, and C may be set for the first account 91. A fourth role D may be set for the second account 92. First, fifth, sixth and seventh roles A, E, F, and G may be set for the third account 93. Furthermore, eighth to tenth roles H, I, and J may be set for the fourth account 94. Eleventh and twelfth roles K and L may be set for the fifth account 95.

Each of the first to twelfth roles A to L assigned to the accounts includes permission on cloud service access and use.

The first user 1 may use the cloud services according to the first and third roles using the first account. Furthermore, the first user 1 may be included in the first group 8, and may use the cloud services using the fourth account having the eighth and ninth roles H and I.

The second user 2 may use the first and third accounts 91 and 93, or may use the fourth and fifth accounts 94 and 95 through the first and second groups 8 and 9.

The management server 50 sets and manages the use of such an account in accordance with a role changed based on the location (IP) and schedule of a user. Furthermore, the management server 50 may set or change a role on the account of a user included in a group through the group.

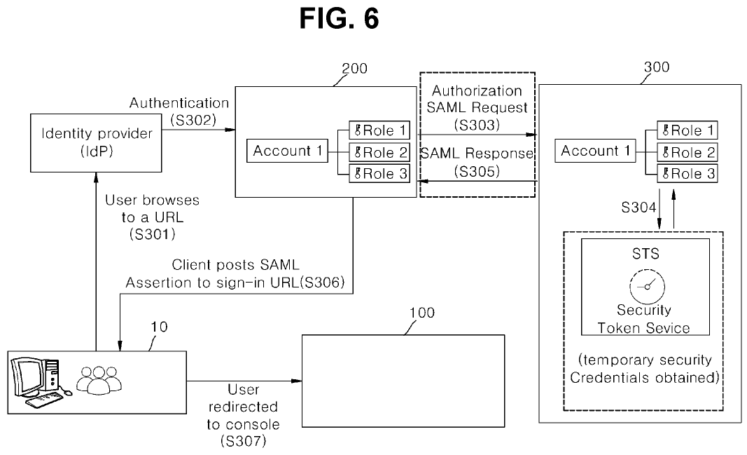

FIG. 6 is a diagram to which reference is made to describe a connection based on a token in the system for managing an integrated account based on a token according to the present disclosure.

As illustrated in FIG. 6, the access unit 200 manages the access of an integrated account to the cloud services based on a multi-token.

A user accesses the cloud services 300 using the terminal 10.

When the terminal 10 attempts access based on an interface for using the cloud services, the terminal is connected using a URL through the IdP(S301).

The management unit 100 of the management server performs primary authentication on an integrated account requested through the terminal 10 (S302). The access unit 200 identifies a role on the account of the user and performs secondary authentication (S303). When the authentication is completed, the terminal is connected to the cloud services through the integrated account.

The access unit 200 confirms the location of the user, that is, an IP to which the terminal is connected, or a role based on the schedule of the corresponding account, and authenticates the user.

The management unit 100 automatically changes a role on the account based on a preset location (IP) or schedule of the user. When the role on the account is changed, access rights corresponding to the location or the progress state of the schedule may be assigned to the user.

The cloud service 300 confirms the role on the account of the user and temporarily assigns security credentials (S304).

The access unit checks a response to the access of the terminal from the cloud services 300 (S305). Corresponding data is transmitted to the terminal 10 (S306).

The terminal 10 succeeds in service access by checking a response to the cloud services, and retransmits related data to the management unit 100.

The management unit 100 stores and manages history data based on the data related to the service use of the user.

Accordingly, the user is connected to the cloud services using the integrated account through the terminal 10, and may be provided with resources for a required service.

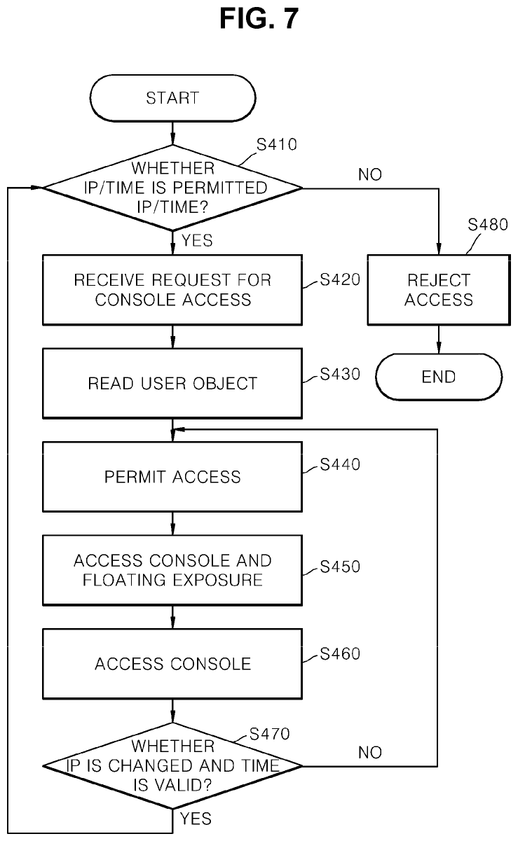

FIG. 7 is a flowchart illustrating an access restriction method based on a location or schedule in the system for managing an integrated account based on a token according to the present disclosure.

As illustrated in FIG. 7, the management unit 100 registers an integrated account according to the use of the cloud services by a user. The management unit automatically assigns and changes a role on the integrated account in accordance with input location information (IP) or schedule.

The terminal 10 attempts access to the cloud services using the integrated account.

The access unit 200 determines whether to permit an access attempt using the integrated account of the terminal 10, based on a location or a schedule (S410).

For example, the access unit 200 determines whether an IP used for a connection is a designated IP based on the integrated account of the terminal 10. Furthermore, the access unit 200 may determine whether an access time is an access permission time based on a schedule set in the integrated account. Furthermore, the access unit 200 may determine an access role based on the type of terminal.

The access unit 200 performs authentication on the access of the cloud services using the integrated account of the terminal 10, based on at least one of a location and a schedule.

When the authentication fails, the access unit 200 rejects the access by the terminal 10 (S480).

When the authentication is completed, the access unit 200 transmits, to the cloud services, a request for access to the cloud services by the terminal 10 (S420).

The cloud services confirms the account of the user and determine whether to permit the access by confirming a role assigned to the account. The cloud services transmit a response to access permission (S440). The access unit transmits the response to the terminal.

Accordingly, the terminal 10 is connected to the cloud services using the integrated account (S460), and performs a task by requesting resources. In this case, available resources may be restricted based on a role assigned to the integrated account.

In the state in which the terminal 10 has been connected to the cloud services, the access unit determines whether access using the integrated account is permitted by continuously checking whether an IP is changed and confirming time for which access is permitted based on a schedule (S470).

In the state in which the terminal 10 has been connected to the cloud services, when the IP is changed or a not-permitted time is reached out of the schedule, access by the terminal 10 is rejected (S480) and the connection is released.

When the cloud services are accessed, the management unit 100 stores history data related to the use of resources by the terminal using the integrated account.

The device operating as described above according to the present embodiment may be implemented in the form of an independent hardware device, and may be driven in a form included in another hardware device, such as a microprocessor or a general-purpose computer system, as at least one processor.

The system and method for managing an integrated account based on a token according to the present disclosure can prevent the generation of an unnecessary account and reduce manpower and costs for monitoring accounts by restricting the generation of an account so that one account is issued to a user in a cloud environment.

Furthermore, the present disclosure greatly improves management convenience by easily managing an access history through a combination of a restricted-account generation policy and user identification information, clarifying an execution target for a manipulation performed in an accessed account, and clarifying a reason for the manipulation.

The present disclosure can prevent a security accident attributable to the carelessness of a user or an administrator by assigning a role to an account. The present disclosure can enhance security by restricting a role on a specific account in such a manner that read permission and write permission are differently set based on a designated task schedule or an accessed location.

Furthermore, the present disclosure has effects in that it can enhance security by automatically assigning a role to an account based on data related to a behavior of a user, such as a task schedule or access location of the user, and can greatly improve user convenience because a role is automatically changed and does not need to be reset.

According to the present disclosure, by providing cloud services using an integrated account based on a token, authentication can be requested through any server without being limited to a specific server. An overload of the server can be prevented. An authentication system can be simplified by easy authentication processing based on multi-sign-in access.

Furthermore, the present disclosure has an effect in that security is enhanced when cloud services are used using an integrated account because cookies do not need to be used in a system through an integrated account based on a token.

The present disclosure has an effect in that scalability is greatly improved because a role on a plurality of cloud services can be shared by processing authentication for the plurality of cloud services based on a token.

The above description is merely a description of the technical spirit of the present disclosure, and those skilled in the art may change and modify the present disclosure in various ways without departing from the essential characteristic of the present disclosure. Accordingly, the embodiments disclosed in the present disclosure should not be construed as limiting the technical spirit of the present disclosure, but should be construed as illustrating the technical spirit of the present disclosure. The scope of the technical spirit of the present disclosure is not restricted by the embodiments.

What is claimed is:

1. An integrated management system comprising:
a plurality of cloud systems configured to provide cloud services;
a terminal configured to access the plurality of cloud systems using an integrated account to which a role has been assigned and to be provided with resources; and
a management server configured to manage a plurality of integrated accounts so that the terminal accesses the plurality of cloud systems using the integrated account,
wherein the management server comprises:
a management unit configured to register the integrated account for accessing the plurality of cloud systems and assign the role on the integrated account based on location information and schedule information of the terminal; and
an access unit configured to authenticate the access to the plurality of cloud systems using the integrated account,
wherein the access unit simplifies an authentication system by managing the access to the cloud services using the integrated account based on a multi-token, and
wherein the management unit maps the integrated account to a role for access to the cloud systems and outputs information on an accessible cloud service based on the location information or the schedule information.

2. The integrated management system of claim 1, wherein the management unit automatically changes the role on the integrated account based on the location information or the schedule information.

3. The integrated management system of claim 1, wherein when the terminal accesses the cloud systems using the integrated account, the management unit stores history data related to a service, resources, and a work history used in the integrated account.

4. The integrated management system of claim 1, wherein the access unit
determines whether an IP of the integrated account is changed while the terminal accesses the cloud systems using the integrated account,
determines whether an access time is an access permission time based on the schedule information, and
releases the access of the terminal if the IP is a not-permitted IP or the access time is not an access permission time.

5. The integrated management system of claim 1, wherein the management unit maps the integrated account and access rights to a requested cloud service so that the terminal is connected to the plurality of cloud systems using the integrated account, without registering individual accounts with the plurality of cloud systems.

6. The integrated management system of claim 1, wherein the management unit manages multiple accounts for a cloud system to be accessed based on only primary authentication for the integrated account.

7. The integrated management system of claim 1, wherein the management unit comprises:
an account management unit configured to register the integrated account and assign the role to the integrated account;
a primary authentication unit configured to primarily authenticate the integrated account and an account of the cloud systems;
a connection unit configured to map the integrated account and the role; and
a schedule unit configured to set the location information and the schedule information for an access permission time in the integrated account.

8. The integrated management system of claim 7, wherein the account management unit
assigns one integrated account to one user, and
registers the integrated account so that the plurality of cloud systems is accessed using the integrated account.

9. The integrated management system of claim 7, wherein the account management unit generates and manages the integrated account in a user or user group unit.

10. The integrated management system of claim 7, wherein the account management unit generates and manages the integrated account for the terminal.

11. The integrated management system of claim 1, wherein the access unit comprises:
an access management unit configured to determine access permission for the cloud systems based on the role assigned to the integrated account; and
a secondary authentication unit configured to secondarily authenticate the access to the cloud systems using the integrated account based on the role.

12. A method of controlling an integrated management system, comprising:
generating an integrated account connected to a plurality of cloud systems providing cloud services;
mapping the integrated account and a role for access to the cloud systems;
assigning a role to the integrated account based on location information or schedule information set in the integrated account;
attempting to access, by a terminal, any one of the plurality of cloud systems using the integrated account;
performing authentication on the integrated account based on a multi-token and determining whether to permit the access to the cloud system based on the role assigned to the integrated account;
outputting information on an accessible cloud service based on the location information or the schedule information; and
accessing, by the terminal, the cloud systems to which the access is permitted and being provided with the cloud service.

13. The method of claim 12, further comprising:
determining whether to permit an IP assigned to the integrated account based on the location information of the integrated account; and
determining whether an access time is time when access is permitted based on the schedule of the integrated account.

14. The method of claim 12, further comprising:
primarily authenticating the integrated account; and
secondarily authenticating the integrated account based on the role, before determining whether to permit the access.

15. The method of claim 12, further comprising
automatically changing the role on the integrated account based on the location information and the schedule information.

16. The method of claim 12, further comprising:
determining whether an IP of the integrated account is changed while the terminal accesses the cloud services of the cloud systems using the integrated account;
determining whether an access time is an access permission time based on the schedule information;
repeatedly determining whether the IP is changed and whether the access time is an access permission time; and
releasing the access of the terminal if the IP is a not-permitted IP or the access time is not an access permission time.
